(19) United States
(12) Patent Application Publication
(10) Pub. No.: US 2026/0086468 A1
(43) Pub. Date: Mar. 26, 2026

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventor: Michinori Fukuma, Kanagawa (JP)

(73) Assignee: FUJIFILM Business Innovation Corp., Tokyo (JP)

(21) Appl. No.: 19/056,641

(22) Filed: Feb. 18, 2025

(30) Foreign Application Priority Data
Sep. 24, 2024 (JP) 2024-165671

(51) Int. Cl. G03G 5/05; G03G 5/047; G03G 21/18

(52) U.S. Cl. CPC G03G 5/0507; G03G 5/047; G03G 21/1814; G03G 21/1839

(57) ABSTRACT

An electrophotographic photoreceptor includes a conductive substrate, a charge generation layer that is disposed on the conductive substrate, a charge transport layer that is disposed on the charge generation layer, and an inorganic protective layer that is disposed on the charge transport layer, in which a capacitance (X1) of the charge transport layer per unit area is 0.90×10⁻⁶ (F/m²) or more and 1.90×10⁻⁶ (F/m²) or less, and a capacitance (X2) of the inorganic protective layer per unit area is 2.40×10⁻⁵ (F/m²) or more and 1.10×10⁻⁴ (F/m²) or less.

### CROSS-REFERENCE TO RELATED APPLICATIONS

This application is based on and claims priority under 35 USC 119 from Japanese Patent Application No. 2024-165671 filed Sep. 24, 2024.

### BACKGROUND

### (i) Technical Field

The present invention relates an electrophotographic photoreceptor, a process cartridge, and an image forming apparatus.

### (ii) Related Art

JP2002-303994A discloses “electrophotographic photoreceptor including, on a conductive substrate, a photosensitive layer that contains at least one of an organic charge generating substance, an organic charge transport substance, or an organic binder resin, in which, in a case where a capacitance of the photosensitive layer is denoted by C (pF/cm²) and a film thickness of the photosensitive layer is denoted by d (μm), a product of C and dis 3,100 or more, and the film thickness of the photosensitive layer is 12 μm or more and 18 μm or less”.

### SUMMARY

Aspects of non-limiting embodiments of the present disclosure relate to an electrophotographic photoreceptor that includes a conductive substrate, a charge generation layer disposed on the conductive substrate, a charge transport layer disposed on the charge generation layer, and an inorganic protective layer disposed on the charge transport layer, in which a decrease in charging property is suppressed and dot reproducibility is excellent as compared with a case where a capacitance (X1) of the charge transport layer per unit area is less than 0.90×10⁻⁶ (F/m²) or more than 1.90×10⁻⁶ (F/m²), or a case where a capacitance (X2) of the inorganic protective layer per unit area is less than 2.40×10⁻⁵ (F/m²) or more than 1.10×10⁻⁴ (F/m²).

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above object include the following.

According to an aspect of the present invention, there is provided an electrophotographic photoreceptor including:
a conductive substrate;
a charge generation layer that is disposed on the conductive substrate;
a charge transport layer that is disposed on the charge generation layer; and
an inorganic protective layer that is disposed on the charge transport layer, in which a capacitance (X1) of the charge transport layer per unit area is 0.90×10⁻⁶ (F/m²) or more and 1.90×10⁻⁶ (F/m²) or less, and
a capacitance (X2) of the inorganic protective layer per unit area is 2.40×10⁻⁵ (F/m²) or more and 1.10×10⁻⁴ (F/m²) or less.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to the present exemplary embodiment;

FIGS. 2A and 2B are schematic views schematically showing an example of a film forming device used for forming an inorganic protective layer of the electrophotographic photoreceptor according to the present exemplary embodiment;

FIG. 3 is a schematic view schematically showing an example of a plasma generator used for forming the inorganic protective layer of the electrophotographic photoreceptor according to the present exemplary embodiment;

FIG. 4 is a view schematically showing the configuration of an example of an image forming apparatus according to the present exemplary embodiment; and

FIG. 5 is a view schematically showing a configuration of another example of the image forming apparatus according to the present exemplary embodiment.

### DETAILED DESCRIPTION

Hereinafter, exemplary embodiments of the present invention will be described. The following descriptions and examples merely illustrate the exemplary embodiments, and do not limit the scope of the present invention.

In the present specification, a numerical range described using “to” represents a range including numerical values listed before and after “to” as the minimum value and the maximum value respectively.

Regarding the numerical ranges described in stages in the present specification, the upper limit or lower limit of a numerical range may be replaced with the upper limit or lower limit of another numerical range described in stages. Furthermore, in the present specification, the upper limit or lower limit of a numerical range may be replaced with values described in examples.

In the present specification, the term “step” includes not only an independent step but a step that is not clearly distinguished from other steps as long as the purpose of the step is achieved.

In the present specification, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present specification, each component may include a plurality of corresponding substances. In a case where the amount of each component in a composition is mentioned in the present specification, and there are two or more kinds of substances corresponding to each component in the composition, unless otherwise specified, the amount of each component means the total amount of two or more kinds of the substances present in the composition.

In the present specification, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present specification, the term “axial direction” of an electrophotographic photoreceptor denotes a direction in which a rotation axis of the electrophotographic photoreceptor extends, and the term “circumferential direction” of the electrophotographic photoreceptor denotes a rotation direction of the electrophotographic photoreceptor.

### Electrophotographic Photoreceptor

The electrophotographic photoreceptor (hereinafter, also referred to as “photoreceptor”) according to the present exemplary embodiment includes a conductive substrate, a charge generation layer, a charge transport layer, and an inorganic protective layer.

The charge generation layer is provided on the conductive substrate.

The charge transport layer contains a binder resin, a charge transport material, and metal oxide particles.

The inorganic protective layer is provided on the charge transport layer.

A capacitance (X1) of the charge transport layer per unit area is 0.90×10⁻⁶ (F/m²) or more and 1.90×10⁻⁶ (F/m²) or less, and a capacitance (X2) of the inorganic protective layer per unit area is 2.40×10⁻⁵ (F/m²) or more and 1.10×10⁻⁴ (F/m²) or less.

With the above-described configuration, the photoreceptor according to the present exemplary embodiment is a photoreceptor in which a decrease in charging property is suppressed and dot reproducibility is excellent. The reason is presumed as follows.

In a lamination-type photoreceptor including an inorganic protective layer, in a case where a negative charge that has been subjected to charging development on the photoreceptor moves to a development member side, a charging potential of the charge transport layer decreases. As a result, in the inorganic protective layer, an end portion of dots of an electrostatic latent image is unstable, lateral flow of the electrostatic latent image occurs, and dot reproducibility is deteriorated. As a result, graininess is reduced.

Here, the movement of the negatively charged development member to the development member side after the charging and development of the photoreceptor is suppressed by increasing a capacitance of the charge transport layer and a capacitance of the inorganic protective layer.

However, in a case where the capacitance of the charge transport layer is excessively increased, charging property is lowered. In addition, in a case where the capacitance of the inorganic protective layer is excessively increased, electrostatic attraction between the toner particles and the latent image charge is decreased. Since a toner image on a drum surface is likely to be disturbed by an alternating electric field during the development, the dot reproducibility due to the lateral flow of the latent image is also deteriorated.

In the photoreceptor according to the present exemplary embodiment, as described above, the capacitance (X1) of the charge transport layer per unit area is 0.90×10⁻⁶ (F/m²) or more and 1.90×10⁻⁶ (F/m²) or less, and the capacitance (X2) of the inorganic protective layer per unit area is 2.40×10⁻⁵ (F/m²) or more and 1.10×10⁻⁴ (F/m²) or less. In this manner, it is possible to suppress the decrease in charging property and the deterioration of the dot reproducibility due to the lateral flow of the latent image.

Due to the above-described reason, it is presumed that the photoreceptor according to the present exemplary embodiment is an electrophotographic photoreceptor in which the decrease in charging property is suppressed and the dot reproducibility is excellent.

Hereinafter, the photoreceptor according to the present exemplary embodiment will be described in detail.

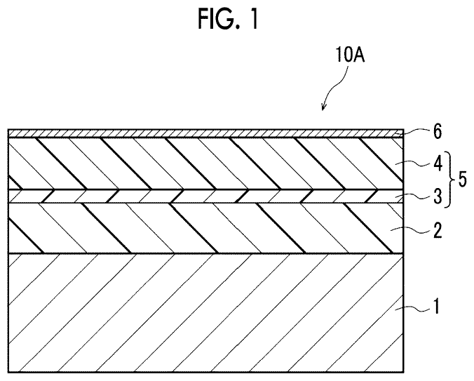

FIG. 1 is a partial cross-sectional view schematically showing an example of a layer configuration of the photoreceptor according to the present exemplary embodiment. A photoreceptor 10A shown in FIG. 1 includes a lamination-type photosensitive layer.

The photoreceptor 10A has a structure in which an undercoat layer 2, a charge generation layer 3, a charge transport layer 4, and an inorganic protective layer 6 are laminated in this order on a conductive substrate 1, and the charge generation layer 3 and the charge transport layer 4 constitute a photosensitive layer 5 (so-called function separation-type photosensitive layer).

The photoreceptor 10A may include an interlayer (not shown) between the undercoat layer 2 and the charge generation layer 3. The undercoat layer 2 may or may not be provided.

Hereinafter, each layer of the photoreceptor will be described in detail. However, each layer of the photoreceptor will be described without a reference numeral.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 10¹³ Ω·cm.

In a case where the electrophotographic photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable a hydrous oxide.

A film thickness of the anodized film is, for example, preferably 0.3 μm or more and 15 μm or less. In a case where the film thickness is within the above-described range, barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 μm or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes. A film thickness of the coating film is, for example, preferably 0.1 μm or more and 5 μm or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 10² Ω·cm or more and 10¹¹ Ω·cm or less.

Among the above, as the inorganic particles having the above-described resistance value, for example, metal oxide particles such as tin oxide particles, titanium oxide particles, zinc oxide particles, and zirconium oxide particles may be used, and zinc oxide particles are particularly preferable.

A specific surface area of the inorganic particles, measured by a BET method, may be, for example, 10 m²/g or more.

A volume-average particle diameter of the inorganic particles may be 50 nm or more and 2,000 nm or less (for example, preferably 60 nm or more and 1,000 nm or less).

A content of the inorganic particles is, for example, preferably 10% by mass or more and 80% by mass or less, and more preferably 40% by mass or more and 80% by mass or less with respect to the binder resin.

The inorganic particles may be subjected to a surface treatment. As the inorganic particles, two or more kinds of inorganic particles subjected to different surface treatments or two or more kinds of inorganic particles having different particle diameters may be used in a form of a mixture.

Examples of a surface treatment agent include a silane coupling agent, a titanate-based coupling agent, an aluminum-based coupling agent, and a surfactant. In particular, for example, a silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane; but the present invention is not limited thereto.

The silane coupling agent may be used in a form of a mixture of two or more kinds thereof. For example, the silane coupling agent having an amino group and other silane coupling agents may be used in combination. Examples of the other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane; but the present invention is not limited thereto.

A surface treatment method using the surface treatment agent may be any method as long as the method is a known method, and any of a dry method or a wet method may be used.

A treatment amount of the surface treatment agent is, for example, preferably 0.5% by mass or more and 10% by mass or less with respect to the inorganic particles.

Here, for example, the undercoat layer may contain an electron-accepting compound (acceptor compound) together with the inorganic particles from the viewpoint of enhancing long-term stability of electrical properties and carrier blocking properties.

Examples of the electron-accepting compound include electron-transporting substances, for example, a compound having an anthraquinone structure; a quinone-based compound such as chloranil and bromanil; a tetracyanoquinodimethane-based compound; a fluorenone compound such as 2,4,7-trinitrofluorenone and 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable; and specifically, anthraquinone, alizarin, quinizarin, anthrarufin, purpurin, or a derivative thereof is preferable.

The electron-accepting compound may be contained in the undercoat layer in a state of being dispersed with the inorganic particles, or in a state of being attached to the surface of the inorganic particles.

Examples of a method of attaching the electron-accepting compound to the surface of the inorganic particles include a dry method and a wet method.

The dry method is, for example, a method of attaching the electron-accepting compound to the surface of the inorganic particles by adding the electron-accepting compound dropwise to the inorganic particles directly or by dissolving the electron-accepting compound in an organic solvent while stirring the inorganic particles with a mixer having a large shearing force and spraying the mixture together with dry air or nitrogen gas. For example, the dropwise addition or spraying of the electron-accepting compound may be performed at a temperature equal to or lower than a boiling point of the solvent. After the dropwise addition or spraying of the electron-accepting compound, the mixture may be further baked at 100° C. or higher. The baking is not particularly limited as long as the temperature and the time are adjusted such that electrophotographic characteristics can be obtained.

The wet method is, for example, a method of attaching the electron-accepting compound to the surface of the inorganic particles by adding the electron-accepting compound to inorganic particles while dispersing the inorganic particles in a solvent by performing using a stirrer, an ultrasonic disperser, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that electrophotographic characteristics can be obtained. In the wet method, the moisture contained in the inorganic particles may be removed before the electron-accepting compound is added, and examples thereof include a method of removing the moisture while stirring and heating the inorganic particles in a solvent and a method of removing the moisture by azeotropically boiling the inorganic particles with a solvent.

The electron-accepting compound may be attached before or after the inorganic particles are subjected to the surface treatment with the surface treatment agent or simultaneously with the surface treatment with the surface treatment agent.

A content of the electron-accepting compound may be, for example, 0.01% by mass or more and 20% by mass or less, preferably 0.01% by mass or more and 10% by mass or less with respect to the inorganic particles.

Examples of the binder resin used for the undercoat layer include a known polymer compound such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and a known material such as a silane coupling agent.

Examples of the binder resin used for the undercoat layer also include a charge-transporting resin having a charge-transporting group, and a conductive resin (for example, polyaniline or the like).

Among the above, as the binder resin used for the undercoat layer, for example, a resin insoluble in a coating solvent of an upper layer is suitable; and a resin obtained by a reaction between at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin, and a curing agent is particularly suitable.

In a case where these binder resins are used in combination of two or more kinds thereof, a mixing proportion thereof is set as necessary.

The undercoat layer may contain various additives for improving the electrical properties, the environmental stability, and the image quality.

Examples of the additive include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be further added to the undercoat layer as the additive.

Examples of the silane coupling agent as the additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in a form of a mixture or a polycondensate of a plurality of compounds.

The undercoat layer may have, for example, a Vickers hardness of 35 or more.

For example, the surface roughness (ten-point average roughness) of the undercoat layer may be adjusted to ½ from 1/(4n)(n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of a polishing method include buff polishing, a sandblast treatment, wet honing, and a grinding treatment.

The formation of the undercoat layer is not particularly limited, and a known forming method is used. For example, a coating film of a coating solution for forming the undercoat layer, in which the above-described components are added to a solvent, is formed, and the coating film is dried and then heated as necessary.

Examples of the solvent for preparing the coating solution for forming the undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming the undercoat layer include known methods such as a roll mill, a ball mill, a vibration ball mill, an attritor, a sand mill, a colloid mill, and a paint shaker.

Examples of the method of coating the conductive substrate with the coating solution for forming the undercoat layer include typical coating methods such as a blade coating method, a wire bar coating method, a spray coating method, a dip coating method, a bead coating method, an air knife coating method, and a curtain coating method.

A film thickness of the undercoat layer is set to, for example, preferably 15 μm or more and more preferably in a range of 20 μm or more and 50 μm or less.

### Interlayer

Although not shown in the drawings, an interlayer may be further provided between the undercoat layer and the photosensitive layer.

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in a form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method.

A film thickness of the interlayer is set to, for example, preferably in a range of 0.1 μm or more and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. For example, the deposition layer of the charge generation material is suitable in a case where an incoherent light source such as a light emitting diode (LED) and an organic electro-luminescence (EL) image array is used.

Examples of the charge generation material include an azo pigment such as a bisazo pigment and a trisazo pigment; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment or a metal-free phthalocyanine pigment is preferably used as the charge generation material, in order to deal with laser exposure in a near-infrared region. Specifically, for example, hydroxy gallium phthalocyanine, chlorogallium phthalocyanine, dichlorotin phthalocyanine, or titanyl phthalocyanine is more preferable.

On the other hand, for example, a fused ring aromatic pigment such as dibromoanthanthrone; a thioindigo-based pigment; a porphyrazine compound; zinc oxide; trigonal selenium; or a bisazo pigment is preferable as the charge generation material in order to deal with laser exposure in a near-ultraviolet region.

The above-described charge generation material may be used even in a case where a non-coherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used as the photosensitive layer.

The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 10¹³ Ω·cm or more.

The binder resins may be used alone or in a form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as a stirrer, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A film thickness of the charge generation layer is set to, for example, preferably in a range of 0.1 μm or more and 5.0 μm or less and more preferably in a range of 0.2 μm or more and 2.0 μm or less.

### Charge Transport Layer

A charge transport layer is, for example, a layer containing a charge transport material and a binder resin. The charge transport layer may be a layer containing a polymer charge transport material.

### Capacitance

In the photoreceptor according to the present exemplary embodiment, the capacitance (X1) of the charge transport layer per unit area is 0.90×10⁻⁶ (F/m²) or more and 1.90×10⁻⁶ (F/m²) or less.

The capacitance (X1) per unit area is, for example, more preferably 0.90×10⁻⁶ (F/m²) or more and 1.50×10⁻⁶ (F/m²) or less, and still more preferably 0.90×10⁻⁶ (F/m²) or more and 1.20×10⁻⁶ (F/m²) or less.

In a case where the capacitance (X1) per unit area is less than 0.90×10⁻⁶ (F/m²), the negative charge charged on the photoreceptor moves to the development member side, and the charging property decreases. As a result, the lateral flow of dots occurs, and the dot reproducibility is deteriorated.

In a case where the capacitance (X1) per unit area is more than 1.90×10⁻⁶ (F/m²), the charging property decreases, and thus the capacitance is less likely to reach the target charging potential and the variation in charging potential occurs.

In a case where the capacitance (X1) of the charge transport layer per unit area satisfies the above-described range, the photoreceptor is less likely to have the decrease in charging property, and the dot reproducibility is improved.

Examples of a method of setting the capacitance (X1) of the charge transport layer per unit area satisfy the above-described range include a method of adjusting a relative permittivity and a film thickness of the charge transport layer, which will be described later.

Examples of the method of adjusting the relative permittivity of the charge transport layer include a method of adjusting the type and amount of the metal oxide particles, and a method of adjusting a degree of hydrophobicity of the metal oxide particles by surface treatment.

### Ratio of Capacitance

For example, it is preferable that a ratio (X1/X2) of the capacitance (X1) of the charge transport layer per unit area to the capacitance (X2) of the inorganic protective layer per unit area, which will be described later, is 0.010 or more and 0.070 or less.

The ratio (X1/X2) of the capacitance (X1) of the charge transport layer per unit area to the capacitance (X2) of the inorganic protective layer per unit area is, for example, more preferably 0.020 or more and 0.060 or less, and still more preferably 0.030 or more and 0.040 or less.

In a case where the ratio (X1/X2) of the capacitance (X1) of the charge transport layer per unit area to the capacitance (X2) of the inorganic protective layer per unit area is 0.010 or more and 0.070 or less, inflow of charges into the development member side is suppressed, and the latent image is less likely to flow laterally. As a result, the dot reproducibility is improved. In addition, the charging property is also less likely to decrease.

Therefore, in a case where the ratio (X1/X2) of the capacitance (X1) of the charge transport layer per unit area to the capacitance (X2) of the inorganic protective layer per unit area satisfies the above-described range, the charging property is less likely to decrease, and the dot reproducibility is improved.

The capacitance C of the charge transport layer per unit area in the electrophotographic photoreceptor is calculated by Expression: C=ε/d (ε: dielectric constant, d: film thickness) from the relative permittivity and the film thickness described later.

$$Dielectric constant ( ε ) = Relative permittivity \times Dielectric constant of vacuum ( {ε}_{0} )$$

$$Dielectric constant ( {ε}_{0} ) of vacuum = 8.854 \times {10}^{- 12}$$

### Metal Oxide Particles

In the photoreceptor according to the present exemplary embodiment, for example, it is preferable that the charge transport layer contains metal oxide particles.

Examples of the metal oxide particles used in the charge transport layer include silica particles, alumina particles, and titanium oxide particles.

Among the above, from the viewpoint of suppressing the deterioration in electrical properties of the photoreceptor, the metal oxide particles are, for example, more preferably silica particles.

A content of the metal oxide particles is, for example, preferably 40% by volume or more and 60% by volume or less.

The content of the metal oxide particles is, for example, more preferably 50% by volume or more and 60% by volume or less, and still more preferably 55% by volume or more and 60% by volume or less.

In a case where the content of the metal oxide particles is 40% by volume or more, static capacitance is also increased together with the relative permittivity. As a result, the dot reproducibility is easily improved.

In a case where the content of the metal oxide particles is 60% by volume or less, the increase in static capacitance together with the relative permittivity is suppressed excessively. As a result, the decrease in charging property is easily suppressed.

In a case where the content of the metal oxide particles contained in the charge transport layer satisfies the above-described range, the photoreceptor is less likely to have the decrease in charging property, and the dot reproducibility is improved.

### Silica Particles

Examples of the silica particles include dry silica particles and wet silica particles.

Examples of the dry silica particles include combustion silica (fumed silica) and explosion silica. The combustion silica is obtained by combustion of a silane compound. The explosion silica is obtained by explosively combusting metal silicon powder.

Examples of the wet silica particles include sedimentation silica, gel silica particles, colloidal silica particles (silica sol particles), and sol-gel silica particles.

The sedimentation silica and the gel silica particles are obtained by a neutralization reaction between sodium silicate and a mineral acid. A silica synthesized and aggregated under alkaline conditions is referred to as the sedimentation silica, and a silica synthesized and aggregated under acidic conditions is referred to as the gel silica particles.

The colloidal silica particles (silica sol particles) are obtained by polymerizing acidic silicate in an alkaline manner.

The sol-gel silica particles are obtained by hydrolysis of an organic silane compound (for example, alkoxysilane).

For example, the silica particles may have a surface subjected to a surface treatment with a hydrophobic agent.

In this manner, the number of silanol groups on the surface of the silica particles is reduced, and the occurrence of the residual potential is easily suppressed.

Examples of the hydrophobic agent include known silane compounds such as chlorosilane, alkoxysilane, and silazane.

Among the above, from the viewpoint of easily suppressing the generation of the residual potential, for example, a silane compound having a trimethylsilyl group, a decylsilyl group, or a phenylsilyl group is desirable as the hydrophobic agent. That is, for example, the surface of the silica particles may have a trimethylsilyl group, a decylsilyl group, or a phenylsilyl group.

Examples of the silane compound having a trimethylsilyl group include trimethylchlorosilane, trimethylmethoxysilane, and 1,1,1,3,3,3-hexamethyldisilazane.

Examples of the silane compound having a decylsilyl group include decyltrichlorosilane, decyldimethylchlorosilane, and decyltrimethoxysilane.

Examples of the silane compound having a phenyl group include triphenylmethoxysilane and triphenylchlorosilane.

### Amount of OH Group in Metal Oxide

In the photoreceptor according to the present exemplary embodiment, in a case where the charge transport layer contains metal oxide particles having an appropriate amount of residual OH groups, the static capacitance is easily controlled within the above-described range together with the relative permittivity.

Therefore, the degree of hydrophobicity of the metal oxide particles in the charge transport layer is, for example, preferably 60% or more, more preferably 62% or more, and still more preferably 65% or more.

In a case where the degree of hydrophobicity of the metal oxide particles in the charge transport layer is 60% or more, it is easy to suppress the increase in static capacitance together with the relative permittivity in the charge transport layer. As a result, the decrease in charging property is easily suppressed.

Accordingly, in a case where the degree of hydrophobicity of the metal oxide particles contained in the charge transport layer satisfies the above-described range, the photoreceptor is less likely to have the decrease in charging property, and the dot reproducibility is improved.

The degree of hydrophobicity of the metal oxide particles is calculated by the following method.

The metal oxide particles (5 g) are added to 100 mL of water, and methanol is added dropwise thereto by 1 mL, thereby precipitating the metal oxide particles. A ratio of the volume of methanol added dropwise to the total volume of the solution is calculated by the following expression, and is defined as the degree of hydrophobicity.

Expression: [(Volume of dropped methanol)/{(Volume of dropped methanol)+(Volume of water)}]×100

Examples of a method of separating the metal oxide particles from the charge transport layer include a method of dissolving the charge transport layer peeled off from the substrate in an organic solvent, and sieving the solution to separate the metal oxide particles that are not dissolved in the organic solvent.

### Relative Permittivity

The relative permittivity of the charge transport layer is, for example, preferably 3.20 or more and 3.40 or less.

In a case where the relative permittivity of the charge transport layer satisfies the above-described range, it is easy to adjust to a desired capacitance. As a result, the charging property of the photoreceptor is less likely to decrease, and the dot reproducibility is improved.

The relative permittivity of the charge transport layer is set to, for example, more preferably in a range of 3.20 or more and 3.35 or less and still more preferably in a range of 3.20 or more and 3.30 or less.

A method of measuring the relative permittivity of the charge transport layer is as follows. The charge transport layer is peeled off from the photoreceptor and used as a sample. The sample is sandwiched in a sample holder of an impedance analyzer (Toyo Corporation) and measured at an AC voltage of 1 V and a frequency of 100 Hz, and the capacitance is calculated by CR parallel fitting. The film thickness is a value obtained by analyzing film thicknesses at 10 sites at equal intervals in an axial direction of the photoreceptor and at 40 sites in total at intervals of 90° in a circumferential direction using a reflection spectroscopic film thickness measuring device, and arithmetically averaging the analyzed values. The relative permittivity is calculated using the calculation expression for the capacitance.

### Film Thickness

The film thickness of the charge transport layer is, for example, preferably 16 μm or more and 30 μm or less.

In a case where the film thickness of the charge transport layer satisfies the above-described range, it is easy to adjust to a desired capacitance. As a result, the charging property of the photoreceptor is less likely to decrease, and the dot reproducibility is improved.

A film thickness of the charge transport layer is set to, for example, more preferably in a range of 18 μm or more and 25 μm or less and still more preferably in a range of 20 μm or more and 23 μm or less.

The film thickness of the charge transport layer is an arithmetic average of measured values measured with an electromagnetic film thickness meter, and measurement points are four points in a circumferential direction at intervals of 90° in the center of the photoreceptor in the axial direction.

### Charge Transport Material

Examples of the charge transport material include a quinone-based compound such as p-benzoquinone, chloranil, bromanil, and anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

From the viewpoint of charge mobility, for example, a triarylamine derivative represented by Structural Formula (a-1) or a benzidine derivative represented by Structural Formula (a-2) is preferable as the charge transport material.

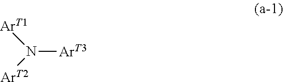

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

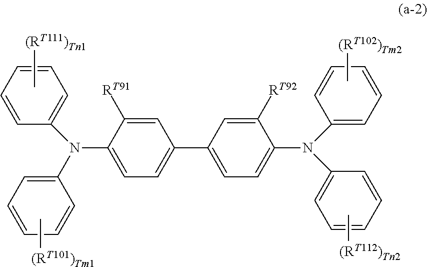

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), in which R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” or a benzidine derivative having “—CH═CH—CH═C(R^{T15})(R^{T16})” is particularly preferable from the viewpoint of the charge mobility.

As the polymer charge transport material, known materials having charge transport properties, such as poly-N-vinylcarbazole and polysilane, are used. In particular, for example, a polyester-based polymer charge transport material is particularly preferable. The polymer charge transport material may be used alone or in combination of the binder resin.

### Binder Resin

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among the above, for example, a polycarbonate resin or a polyarylate resin is preferable as the binder resin. The binder resins may be used alone or in combination of two or more kinds thereof.

A blending ratio between the charge transport material and the binder resin is, for example, preferably 10:1 to 1:5 in terms of mass ratio.

The charge transport layer may also contain other known additives.

The formation of the charge transport layer is not particularly limited, and a known forming method is used. For example, a coating film of a coating solution for forming the charge transport layer, in which the above-described components are added to a solvent, is formed, and the coating film is dried and then heated as necessary.

Examples of the solvent for preparing the coating solution for forming the charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

### Inorganic Protective Layer

The inorganic protective layer is provided, for example, for the purpose of preventing a chemical change in the photosensitive layer during charging and further improving a mechanical strength of the photosensitive layer.

### Capacitance

In the photoreceptor according to the present exemplary embodiment, the capacitance (X2) of the inorganic protective layer per unit area is 2.40×10⁻⁵ (F/m²) or more and 1.10×10⁻⁴ (F/m²) or less.

The capacitance (X2) per unit area is, for example, more preferably 2.40×10⁻⁵ (F/m²) or more and 5.30×10⁻⁵ (F/m²) or less, and still more preferably 2.80×10⁻⁵ (F/m²) or more and 3.50×10⁻⁵ (F/m²) or less.

In a case where the capacitance (X2) per unit area is less than 2.40×10⁻⁵ (F/m²), the negative charge charged on the photoreceptor moves to the development member side, and the charging potential is decreased. As a result, the lateral flow of dots occurs, and the dot reproducibility is deteriorated. In addition, the graininess is reduced.

In a case where the capacitance (X2) per unit area is more than 1.10×10⁻⁴ (F/m²), the lateral flow of the latent image occurs, and the dot reproducibility is deteriorated. In addition, the graininess is reduced.

In a case where the capacitance (X2) of the inorganic protective layer per unit area satisfies the above-described range, the photoreceptor is less likely to have the decrease in charging property, and the dot reproducibility is improved.

Examples of a method of setting the capacitance (X2) of the inorganic protective layer per unit area satisfy the above-described range include a method of adjusting a relative permittivity and a film thickness of the inorganic protective layer, which will be described later.

Examples of the method of adjusting the relative permittivity of the inorganic protective layer include a method of adjusting an element compositional ratio (oxygen/Group 13 element) of oxygen to a Group 13 element of the inorganic protective layer.

Examples of the method of adjusting the element compositional ratio (oxygen/Group 13 element) include a method of adjusting a flow rate ratio of an oxygen gas and a Group 13 element-containing compound gas in a method of forming the inorganic protective layer.

Here, the capacitance (X2) of the inorganic protective layer per unit area is calculated in the same manner as the capacitance (X1) of the charge transport layer per unit area.

Same as the capacitance of the charge transport layer, the capacitance C of the inorganic protective layer per unit area in the electrophotographic photoreceptor is calculated by Expression: C=ε/d (ε: dielectric constant, d: film thickness).

$$Dielectric constant ( ε ) = Relative permittivity \times Dielectric constant of vacuum ( {ε}_{0} )$$

$${ε}_{0} = 8.854 \times {10}^{- 12}$$

### Relative Permittivity

The relative permittivity of the inorganic protective layer is, for example, preferably 11.0 or more and 12.0 or less.

In a case where the relative permittivity of the inorganic protective layer satisfies the above-described range, it is easy to adjust to a desired capacitance. As a result, the dot reproducibility is improved.

The relative permittivity of the inorganic protective layer is set to, for example, more preferably in a range of 11.0 or more and 11.5 or less and still more preferably in a range of 11.0 or more and 11.3 or less.

A method of measuring the relative permittivity of the inorganic protective layer is as follows. The inorganic protective layer is peeled off from the photoreceptor and used as a sample. The sample is sandwiched in a sample holder of an impedance analyzer (Toyo Corporation) and measured at an AC voltage of 1 V and a frequency of 100 Hz, and the capacitance is calculated by CR parallel fitting. The film thickness is a value obtained by analyzing layer thicknesses at 10 sites at equal intervals in an axial direction of the photoreceptor and at 40 sites in total at intervals of 90° in a circumferential direction using a reflection spectroscopic film thickness measuring device, and arithmetically averaging the analyzed values. The relative permittivity is calculated using the above expression.

### Film Thickness

The film thickness of the inorganic protective layer is, for example, preferably 1.0 μm or more and 4.0 μm or less.

In a case where the film thickness of the inorganic protective layer satisfies the above-described range, it is easy to adjust to a desired capacitance. As a result, the dot reproducibility is improved.

The film thickness of the inorganic protective layer is set to, for example, more preferably in a range of 2.0 μm or more and 3.5 μm or less and still more preferably in a range of 2.5 μm or more and 3.0 μm or less.

The film thickness of the inorganic protective layer is an arithmetic average of measured values measured with an electromagnetic film thickness meter, and measurement points are four points in a circumferential direction at intervals of 90° in the center of the photoreceptor in the axial direction.

### Formulation of Inorganic Protective Layer

The inorganic protective layer is an inorganic material layer. Examples of the inorganic material include metal oxides such as gallium oxide, aluminum oxide, zinc oxide, titanium oxide, indium oxide, tin oxide, and boron oxide; metal nitrides such as gallium nitride, aluminum nitride, zinc nitride, titanium nitride, indium nitride, tin nitride, and boron nitride; carbon-based or silicon-based inorganic materials such as diamond-like carbon, amorphous carbon, hydrogenated amorphous carbon, hydrogenated and fluorinated amorphous carbon, amorphous silicon carbide, hydrogenated amorphous silicon carbide, amorphous silicon, and hydrogenated amorphous silicon; and mixed crystals thereof.

From the viewpoint of abrasion resistance and electrical properties of the photoreceptor, the inorganic protective layer is, for example, preferably a layer containing a metal oxide, more preferably a layer containing Group 13 element and an oxygen element, and still more preferably a layer containing gallium oxide or a layer containing aluminum oxide. The inorganic protective layer may contain one metal oxide or two or more metal oxides.

For example, the inorganic protective layer preferably contains oxygen and a Group 13 element.

The inorganic protective layer may contain, for example, at least a Group 13 element (particularly, gallium) and oxygen, and may contain hydrogen as necessary. By adding the hydrogen, it is easy to control physical characteristics of the inorganic protective layer formed by containing at least a Group 13 element (particularly gallium) and oxygen. For example, in an inorganic protective layer containing gallium, oxygen, and hydrogen (for example, an inorganic protective layer formed of gallium oxide containing hydrogen), it is easier to control a volume resistivity in a range of 10⁹ Ω·cm or more and 10¹⁴ Ω·cm or less by changing a compositional ratio [O]/[Ga] from 1.0 to 1.5.

Here, in a case where the inorganic protective layer is constituted by containing gallium, oxygen, and hydrogen as necessary, the element compositional ratio is as follows from the viewpoint of maintaining light transmittance of the inorganic protective layer and suppressing the movement of charges during development.

The element compositional ratio of gallium is 40 at % or more and 43 at % or less, for example, desirably 40 at % or more and 42 at % or less and more desirably 40 at % or more and 41 at % or less, with respect to total constituent elements of the inorganic protective layer.

The element compositional ratio of oxygen is 57 at % or more and 60 at % or less, for example, desirably 58 at % or more and 60 at % or less and more desirably 59 at % or more and 60 at % or less, with respect to total constituent elements of the inorganic protective layer.

The element compositional ratio (oxygen/Group 13 element) of oxygen to the Group 13 element in the inorganic protective layer is, for example, preferably 1.40 or more and 1.50 or less.

The element compositional ratio (oxygen/Group 13 element) of oxygen to the Group 13 element in the inorganic protective layer is set to, for example, more preferably in a range of 1.45 or more and 1.50 or less, and still more preferably in a range of 1.48 or more and 1.50 or less.

In a case where the element compositional ratio (oxygen/Group 13 element) of oxygen to the Group 13 element in the inorganic protective layer is 1.40 or more and 1.50 or less, the relative permittivity is easily adjusted, and the capacitance can be controlled within the above-described range.

Here, the element compositional ratio of each element in the inorganic protective layer is obtained by Rutherford backscattering spectrometry (hereinafter, referred to as “RBS”).

In the RBS, 3SDH Pelletron of National Electron Corporation is used as an accelerator, RBS-400 of CE & A is used as an end station, and 3S-R10 is used as a system. HYPRA program or the like of CE & A is used for analysis.

Measurement conditions of the RBS are that He++ ion beam energy is 2.275 eV, a detection angle is 160°, and a Grazing Angle is approximately 109° with respect to an incident beam.

The RBS measurement is specifically performed as follows. First, the He++ ion beam is incident perpendicular to a sample, a detector is set at 160° with respect to the ion beam, and a backscattered He signal is measured. The compositional ratio is determined from the detected He energy and intensity. In order to improve the accuracy of obtaining the compositional ratio, the spectrum may be measured at two detection angles. The accuracy is improved by measuring and cross-checking at two detection angles with different depth direction resolution or backscattering mechanics.

The number of He atoms backscattered by a target atom is determined only by three factors: 1) the atomic number of a target atom, 2) the energy of the He atom before scattering, and 3) the scattering angle.

In a case where the element compositional ratio (oxygen/Group 13 element) of oxygen to the Group 13 element in the inorganic protective layer satisfies the above-described range, the charging property of the photoreceptor is less likely to decrease, and the dot reproducibility is improved.

From the viewpoint of maintaining an electrostatic latent image, a volume resistivity of the inorganic protective layer is, for example, preferably 1.0×10¹⁰ Ω·cm or more, and more preferably 1.0×10¹¹ Ω·cm or more.

A method of measuring the volume resistivity of the inorganic protective layer is as follows.

The inorganic protective layer is peeled off from the photoreceptor and used as a sample. The sample is sandwiched in a sample holder of an impedance analyzer (Toyo Corporation), the resistance value is measured at an AC voltage of 1 V and a frequency of 100 Hz, and the calculation is performed based on the area of an electrode and the thickness of the sample.

### Formation of Inorganic Protective Layer

Examples of a method of forming the inorganic protective layer include known vapor phase film forming methods such as plasma chemical vapor deposition (CVD), organic metal vapor phase growth, molecular beam epitaxy, vapor deposition, and sputtering. For example, the inorganic protective layer can be formed by applying the plasma CVD film deposition device and film deposition conditions described in JP2014-191179A.

Hereinafter, the formation of the inorganic surface layer will be described with reference to specific examples by showing an example of a film forming device in the drawings. A method of forming an inorganic surface layer formed by containing gallium, oxygen, and hydrogen will be described below, but the method is not limited thereto, and a known forming method may be employed depending on the formulation of the target inorganic surface layer.

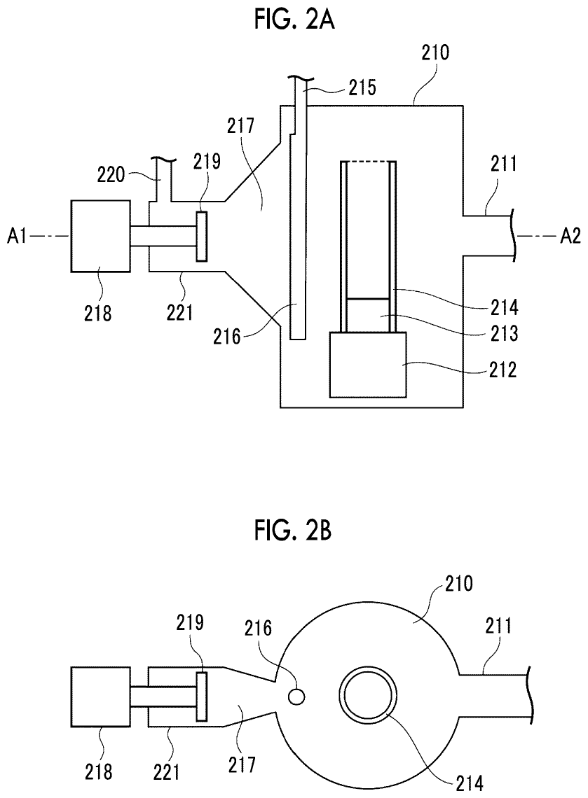

FIGS. 2A and 2B are schematic views schematically showing an example of a film forming device used for forming the inorganic surface layer of the electrophotographic photoreceptor according to the present exemplary embodiment, in which FIG. 2A is a schematic cross-sectional view in a case where the film forming device is viewed from a side surface, and FIG. 2B is a schematic cross-sectional view taken along line A1-A2 of the film forming device shown in FIG. 2A. In FIGS. 2A and 2B, the reference numeral 210 represents a film forming chamber, the reference numeral 211 represents an exhaust port, the reference numeral 212 represents a substrate rotating portion, the reference numeral 213 represents a substrate support member, the reference numeral 214 represents a substrate, the reference numeral 215 represents a gas introduction pipe, the reference numeral 216 represents a shower nozzle having an opening for injecting gas introduced from the gas introduction pipe 215, the reference numeral 217 represents a plasma diffusion portion, the reference numeral 218 represents a high-frequency power supply portion, the reference numeral 219 represents a flat plate electrode, the reference numeral 220 represents a gas introduction pipe, and the reference numeral 221 represents a high-frequency discharge tube portion.

In the film forming device shown in FIGS. 2A and 2B, the exhaust port 211 connected to a vacuum exhaust device (not shown) is provided at one end of the film forming chamber 210, and a plasma generator consisting of the high-frequency power supply portion 218, the flat plate electrode 219, and the high-frequency discharge tube portion 221 is provided on a side of the film forming chamber 210 opposite to a side where the exhaust port 211 is provided.

The plasma generator is composed of the high-frequency discharge tube portion 221, the flat plate electrode 219 disposed in the high-frequency discharge tube portion 221 and having a discharge surface provided on a side of the exhaust port 211, and the high-frequency power supply portion 218 disposed outside the high-frequency discharge tube portion 221 and connected to the surface opposite to the discharge surface of the flat plate electrode 219. The gas introduction pipe 220 for supplying gas into the high-frequency discharge tube portion 221 is connected to the high-frequency discharge tube portion 221, and the other end of the gas introduction pipe 220 is connected to a first gas supply source (not shown).

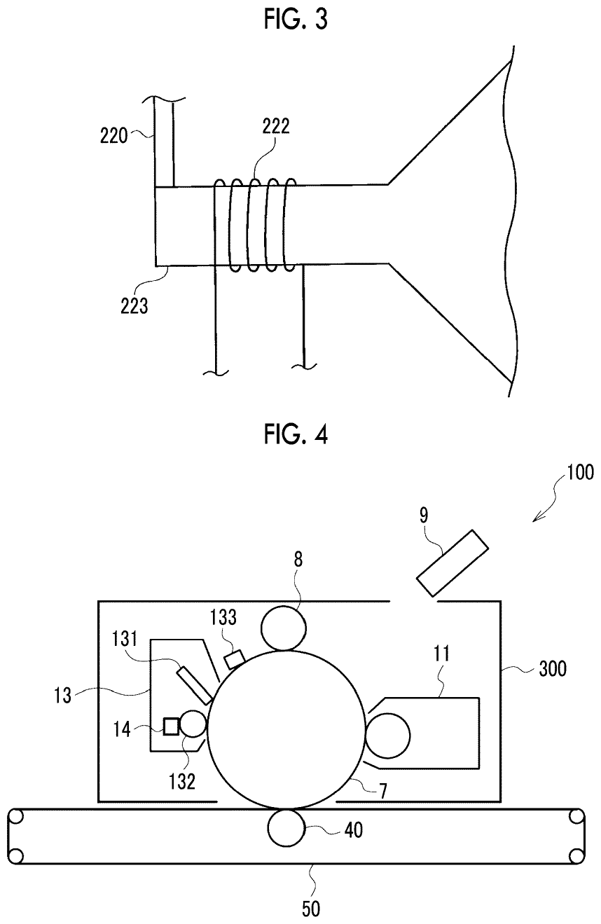

A plasma generator shown in FIG. 3 may be used in place of the plasma generator provided in the film forming device shown in FIGS. 2A and 2B. FIG. 3 is a schematic view schematically showing another example of the plasma generator used in the film forming device shown in FIG. 2, and is a side view of the plasma generator. In FIG. 3, the reference numeral 222 represents a high-frequency coil, the reference numeral 223 represents a quartz tube, and the reference numeral 220 represents the same gas introduction pipe as shown in FIGS. 2A and 2B. The plasma generator consists of the quartz tube 223 and the high-frequency coil 222 provided along the outer peripheral surface of the quartz tube 223, and one end of the quartz tube 223 is connected to the film forming chamber 210 (not shown in FIG. 3). In addition, the gas introduction pipe 220 for introducing gas into the quartz tube 223 is connected to the other end of the quartz tube 223.

In FIGS. 2A and 2B, the rod-like shower nozzle 216 extending along the discharge surface is connected to the discharge surface side of the flat plate electrode 219, one end of the shower nozzle 216 is connected to the gas introduction pipe 215, and the gas introduction pipe 215 is connected to a second gas supply source (not shown) provided outside the film forming chamber 210.

In addition, the substrate rotating portion 212 is provided in the film forming chamber 210, and the cylindrical substrate 214 is attached to the substrate rotating portion 212 through the substrate support member 213 such that the shower nozzle 216 in the longitudinal direction and the substrate 214 in the axial direction face each other. In the film formation, the substrate 214 rotates in the circumferential direction along with the rotation of the substrate rotating portion 212. For example, a photoreceptor or the like laminated up to an organic photosensitive layer in advance is used as the substrate 214.

The formation of the inorganic surface layer is carried out, for example, in the following manner.

First, oxygen gas (or helium (He) diluted oxygen gas), helium (He) gas, and, as necessary, hydrogen (H₂) gas are introduced into the high-frequency discharge tube portion 221 from the gas introduction pipe 220, and a radio wave at a frequency of 13.56 MHz is supplied from the high-frequency power supply portion 218 to the flat plate electrode 219. Here, the plasma diffusion portion 217 is formed such that the plasma diffusion unit radially extends from the discharge surface side of the flat plate electrode 219 to the exhaust port 211 side. Here, the gas introduced from the gas introduction pipe 220 flows through the film forming chamber 210 from the flat plate electrode 219 side to the exhaust port 211 side. The flat plate electrode 219 may be formed such that the electrode is surrounded by a ground shield.

Next, a non-single crystal film containing gallium, oxygen, and hydrogen is formed on the surface of the substrate 214 by introducing trimethyl gallium gas into the film forming chamber 210 through the gas introduction pipe 215 and the shower nozzle 216 positioned on the downstream side of the flat plate electrode 219 serving as an activation device.

As the substrate 214, for example, a substrate on which the organic photosensitive layer is formed is used.

A temperature of the surface of the substrate 214 in the film formation of the inorganic surface layer is, for example, desirably 150° C. or lower, more desirably 100° C. or lower, and particularly desirably 30° C. or higher and 100° C. or lower, because an organic photoreceptor including an organic photosensitive layer is used.

In a case where the temperature of the surface of the substrate 214 is 150° C. or lower at the beginning of the film formation, but is higher than 150° C. due to the influence of the plasma, since the organic photosensitive layer may be damaged due to heat, for example, it is desirable that the surface temperature of the substrate 214 is controlled in consideration of the influence.

The temperature of the surface of the substrate 214 may be controlled by at least one of a heating device or a cooling device (not shown in the drawing) or may be controlled by a natural increase in temperature during discharging. In a case where the substrate 214 is heated, a heater may be installed on the outside or inside of the substrate 214. In a case where the substrate 214 is cooled, gas or a liquid for cooling may be circulated inside the substrate 214.

In a case where an increase in the temperature of the surface of the substrate 214 due to discharge is intended to be avoided, it is effective to adjust the high-energy gas flow coming into contact with the surface of the substrate 214. In this case, the conditions such as the gas flow rate, the discharge output, and the pressure are adjusted to obtain a required temperature.

In addition, an organometallic compound containing aluminum in place of trimethyl gallium gas or a hydroxide such as diborane can also be used, and two or more kinds thereof may be mixed.

For example, in a case where a film containing nitrogen and indium is formed on the substrate 214 by introducing trimethyl indium into the film forming chamber 210 through the gas introduction pipe 215 and the shower nozzle 216 at the initial stage of the formation of the inorganic surface layer, the film absorbs ultraviolet rays that are generated and deteriorate the organic photosensitive layer in a case of continuous film formation. Therefore, damage to the organic photosensitive layer due to the generation of ultraviolet rays in the film formation is suppressed.

In addition, as a method of doping the dopant in the film formation, SiH₃ or SnH₄ for an n-type, or biscyclopentadienyl magnesium, dimethyl calcium, or dimethyl strontium for a p-type is used in a gas state. Furthermore, the dopant element is doped into the surface layer by a known method such as a thermal diffusion method or an ion implantation method.

Specifically, a conductive type inorganic surface layer of an n-type, a p-type, or the like is obtained, for example, by introducing gas containing at least one or more dopant elements into the film forming chamber 210 through the gas introduction pipe 215 and the shower nozzle 216.

In the film forming device described with reference to FIGS. 2A, 2B, and 3, active nitrogen or active hydrogen formed by the discharge energy may be independently controlled by providing a plurality of activation devices, or gas having both nitrogen atoms and hydrogen atoms at the same time, such as NH₃, may also be used. H₂ may be further added. In addition, the conditions for liberating and generating active hydrogen from the organometallic compound may be used.

In this manner, carbon atoms, gallium atoms, nitrogen atoms, hydrogen atoms, and the like, which have been activated, are present on the surface of the substrate 214 in a controlled state. The activated hydrogen atoms have an effect of desorbing hydrogen of a hydrocarbon group such as a methyl group or an ethyl group constituting an organometallic compound as a molecule.

Therefore, a hard film (inorganic surface layer) constituting a three-dimensional bond is formed.

The plasma generator of the film forming device shown in FIGS. 2A, 2B, and 3 uses a high-frequency oscillation device, but the present invention is not limited thereto, and for example, a microwave oscillation device or an electrocyclotron resonance type or a helicon plasma type device may be used. In addition, in a case of a high-frequency oscillation device, an inductive type or a capacitive type may be used.

Furthermore, two or more kinds of these devices may be used in combination, or two or more of the same devices may be used. In order to suppress an increase in the temperature of the surface of the substrate 214 due to irradiation with plasma, for example, a high-frequency oscillation device is desirable, but a device that suppresses irradiation with heat may be provided.

In a case where two or more different kinds of plasma generators are used, for example, it is desirable that discharge occurs simultaneously at the same pressure in the plasma generators. In addition, a pressure difference may be provided between a region of discharge and a region of film formation (portion where a substrate is installed). These devices may be arranged in series with respect to the gas flow formed in the film forming device from the portion where the gas is introduced to the portion where the gas is discharged, or all the devices may be arranged to face the film forming surface of the substrate.

For example, in a case where two kinds of plasma generators are installed in series with respect to the gas flow, according to the example of the film forming device shown in FIGS. 2A and 2B, the plasma generators may be used as the second plasma generator that causes a discharge in the film forming chamber 210 using the shower nozzle 216 as an electrode. In the case, for example, a high-frequency voltage is applied to the shower nozzle 216 through the gas introduction pipe 215 to cause a discharge in the film forming chamber 210 using the shower nozzle 216 as an electrode. Alternatively, a cylindrical electrode is provided between the substrate 214 and the flat plate electrode 219 in the film forming chamber 210 instead of using the shower nozzle 216 as an electrode, and the cylindrical electrode is used to cause a discharge in the film forming chamber 210.

In addition, in a case where two different kinds of plasma generators are used under the same pressure and, for example, in a case where a microwave oscillation device and a high-frequency oscillation device are used, the excitation energies of the excitation species can be greatly changed, and the film quality can be effectively controlled. Furthermore, the discharge may be performed at the vicinity of the atmospheric pressure (70,000 Pa or more and 110,000 Pa or less). In a case of performing discharge at the vicinity of the atmospheric pressure, for example, it is desirable to use He as a carrier gas.

In the formation of the inorganic surface layer, for example, the substrate 214 in which an organic photosensitive layer is formed on the substrate is installed in the film forming chamber 210, and mixed gases having different compositions are introduced, thereby forming the inorganic surface layer.

In addition, for example, in a case of performing discharge by high-frequency discharge, the frequency is desirably set to be in a range of 10 kHz or more and 50 MHz or less as a film forming condition in order to carry out satisfactory film formation at a low temperature. Furthermore, the output depends on the size of the substrate 214, for example, but is desirably set to be in a range of 0.01 W/cm² or more and 0.2 W/cm² or less with respect to the surface area of the substrate. The rotation speed of the substrate 214 is, for example, desirably in a range of 0.1 rpm or more and 500 rpm or less.

In addition to the above-described inorganic material, the inorganic protective layer may contain one or more elements selected from C, Si, Ge, and Sn in the case of n-type, for example, for controlling the conductive type. In addition, for example, in a case of p-type, one or more elements selected from N, Be, Mg, Ca, and Sr may be contained.

The film thickness of each layer of the photosensitive layer is an arithmetic average of measured values measured with an electromagnetic film thickness meter, and measurement points are four points in a circumferential direction at intervals of 90° in the center of the photoreceptor in the axial direction.

### Image Forming Apparatus (and Process Cartridge)

The image forming apparatus according to the present exemplary embodiment includes the electrophotographic photoreceptor, a charging unit that charges a surface of the electrophotographic photoreceptor, an electrostatic latent image forming unit that forms an electrostatic latent image on the charged surface of the electrophotographic photoreceptor, a developing unit that develops the electrostatic latent image formed on the surface of the electrophotographic photoreceptor with a developer containing a toner to form a toner image, and a transferring unit that transfers the toner image to a surface of a recording medium. The above-described electrophotographic photoreceptor according to the present exemplary embodiment is adopted as the electrophotographic photoreceptor.

As the image forming apparatus according to the present exemplary embodiment, a known image forming apparatus such as an apparatus including a fixing unit that fixes the toner image transferred to the surface of a recording medium; a direct transfer-type apparatus that transfers the toner image formed on the surface of the electrophotographic photoreceptor directly to the recording medium; an intermediate transfer-type apparatus that primarily transfers the toner image formed on the surface of the electrophotographic photoreceptor to a surface of an intermediate transfer member and secondarily transfers the toner image transferred to the surface of the intermediate transfer member to the surface of the recording medium; an apparatus including a cleaning unit that cleans the surface of the electrophotographic photoreceptor after the transfer of the toner image and before the charging; an apparatus including a charge erasing unit that erases the charges on the surface of the electrophotographic photoreceptor by applying the charge erasing light after the transfer of the toner image and before the charging; or an apparatus including an electrophotographic photoreceptor heating member for increasing the temperature of the electrophotographic photoreceptor and decreasing the relative temperature is adopted.

In a case of the intermediate transfer-type apparatus, the transferring unit has a configuration including an intermediate transfer member with surface on which the toner image will be transferred, a primary transferring unit that performs primary transfer to transfer the toner image formed on the surface of the electrophotographic photoreceptor to the surface of the intermediate transfer member, and a secondary transferring unit that performs secondary transfer to transfer the toner image transferred to the surface of the intermediate transfer member to the surface of a recording medium.

The image forming apparatus according to the present exemplary embodiment may be any of a dry development-type image forming apparatus or a wet development-type (development type using a liquid developer) image forming apparatus.

In the image forming apparatus according to the present exemplary embodiment, for example, a portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging unit, an electrostatic latent image forming unit, a developing unit, and a transferring unit, in addition to the electrophotographic photoreceptor.

An example of the image forming apparatus according to the present exemplary embodiment will be shown below, but the present invention is not limited thereto. Hereinafter, among the parts shown in the drawing, main parts will be described, and others will not be described.

FIG. 4 is a view schematically showing a configuration of an example of the image forming apparatus according to the present exemplary embodiment.

As shown in FIG. 4, an image forming apparatus 100 according to the present exemplary embodiment includes a process cartridge 300 including an electrophotographic photoreceptor 7, an exposure device 9 (an example of the electrostatic latent image forming unit), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300; the transfer device 40 is disposed at a position that faces the electrophotographic photoreceptor 7 through the intermediate transfer member 50; and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transferring unit. In the image forming apparatus 100, a control device 60 (an example of the control unit) is a device that controls the operation of each device and each member in the image forming apparatus 100 and is disposed in connection with each device and each member.

The process cartridge 300 in FIG. 4 integrally supports the electrophotographic photoreceptor 7, a charging device 8 (an example of the charging unit), a developing device 11 (an example of the developing unit), and a cleaning device 13 (an example of the cleaning unit) in a housing. The cleaning device 13 has a cleaning blade (an example of a cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 4 shows an example of an image forming apparatus including a fibrous member 132 (roll shape) that supplies a lubricant 14 to the surface of the electrophotographic photoreceptor 7 and a fibrous member 133 (flat brush shape) that assists the cleaning, but these are disposed as necessary.

Hereinafter, each configuration of the image forming apparatus according to the present exemplary embodiment will be described.

### Charging Device

As the charging device 8, for example, a contact-type charger formed of a conductive or semi-conductive charging roller, a charging brush, a charging film, a charging rubber blade, a charging tube, or the like is used. In addition, a known charger such as a non-contact type roller charger, and a scorotoron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. A wavelength of the light source is within the spectral sensitivity region of the electrophotographic photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. In addition, a surface emission-type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the electrophotographic photoreceptor 7 using a brush, a roller, or the like. Among the above, for example, a developing roller in which a developer is retained on a surface is preferably used.

The developer used in the developing device 11 may be a one-component developer containing only a toner or a two-component developer containing a toner and a carrier. In addition, the developer may be magnetic or non-magnetic. Known developers are employed as the developer.

### Cleaning Device

As the cleaning device 13, a cleaning blade-type device including the cleaning blade 131 is used.

In addition to the cleaning blade-type device, a fur brush cleaning-type device or a simultaneous development cleaning-type device may be adopted.

### Transfer Device

Examples of the transfer device 40 include a known transfer charger such as a contact type transfer charger using a belt, a roller, a film, a rubber blade, or the like, and a scorotron transfer charger or a corotron transfer charger using corona discharge.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. In addition, as the form of the intermediate transfer member, a drum-like intermediate transfer member may be used in addition to the belt-like intermediate transfer member.

### Control Device

The control device 60 is configured as a computer that controls the entire device and performs various calculations. Specifically, the control device 60 includes, for example, a central processing unit (CPU), a read only memory (ROM) storing various programs, a random access memory (RAM) used as a work area in a case of executing a program, a non-volatile memory storing various pieces of information, and an input/output interface (I/O). The CPU, the ROM, the RAM, the non-volatile memory, and the I/O are connected to each other through a bus. Each unit of the image forming apparatus 100, such as the electrophotographic photoreceptor 7 (including a drive motor 30), the charging device 8, the exposure device 9, the developing device 11, and the transfer device 40, is connected to the I/O.

The CPU executes, for example, programs (for example, control programs of an image forming sequence, a recovery sequence, and the like) stored in the ROM or the non-volatile memory, and controls the operation of each unit of the image forming apparatus 100. The RAM is used as a work memory. For example, the programs executed by the CPU, data necessary for processing of the CPU, and the like are stored in the ROM and the non-volatile memory. The control programs and various pieces of data may be stored in another storage device such as a storage unit, or may be acquired from an outside through a communication unit.

Various drives may be connected to the control device 60. Examples of the various drives include a device that reads data from a computer-readable portable recording medium, such as a flexible disk, an optical magnetic disk, a CD-ROM, a DVD-ROM, or a universal serial bus (USB) memory, or writes data on a recording medium. In a case where various drives are provided, the control program may be recorded in a portable recording medium and executed by the corresponding drive reading the program.

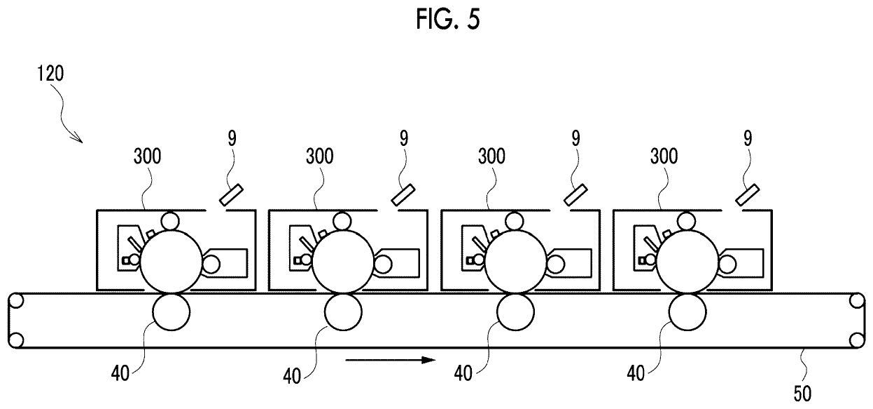

FIG. 5 is a view schematically showing a configuration of another example of the image forming apparatus according to the present exemplary embodiment.

An image forming apparatus 120 shown in FIG. 5 is a tandem type multicolor image forming apparatus in which four process cartridges 300 are mounted. The image forming apparatus 120 is formed such that the four process cartridges 300 are arranged in parallel on the intermediate transfer member 50, and one electrophotographic photoreceptor is used for each color. The image forming apparatus 120 has the same configuration as the image forming apparatus 100, except that the image forming apparatus 120 is of a tandem type.

The image forming apparatus 100 according to the present exemplary embodiment is not limited to the above-described configuration; and may include, for example, a first charge erasing device that is provided in the periphery of the electrophotographic photoreceptor 7 and on the downstream side of the transfer device 40 in the rotation direction of the electrophotographic photoreceptor 7 and on the upstream side of the cleaning device 13 in the rotation direction of the electrophotographic photoreceptor and aligns the polarity of the remaining toner and facilitating removal with a cleaning brush, or a second charge erasing device that is provided on the downstream side of the cleaning device 13 in the rotation direction of the electrophotographic photoreceptor and on the upstream side of the charging device 8 in the rotation direction of the electrophotographic photoreceptor and erases the charges on the surface of the electrophotographic photoreceptor 7.

In addition, the image forming apparatus 100 according to the present exemplary embodiment is not limited to the above-described configuration, and a known configuration, for example, a direct transfer type image forming apparatus that directly transfers a toner image formed on the electrophotographic photoreceptor 7 to a recording medium may be employed.

### EXAMPLES

Hereinafter, exemplary embodiments of the invention will be specifically described based on examples. However, the exemplary embodiments of the invention are not limited to the examples.

In the following description, unless otherwise specified, “parts” and “%” are based on mass.

In the following description, the synthesis, the production, the treatment, the measurement, and the like are carried out at normal temperature (25° C.±3° C.), unless otherwise specified.

### Example 1

### Formation of Undercoat Layer

100 parts by mass of zinc oxide (average particle diameter: 70 nm; manufactured by Tayca Corporation, specific surface area value: 15 m²/g) is stirred and mixed with 500 parts by mass of tetrahydrofuran, 1.3 parts by mass of a silane coupling agent (KBM503; manufactured by Shin-Etsu Chemical Co., Ltd.) is added thereto, and the mixture is stirred for 2 hours. Thereafter, the tetrahydrofuran is distilled off by vacuum distillation and baked at 120° C. for 3 hours to obtain zinc oxide surface-treated with a silane coupling agent.

110 parts by mass of the above-described surface-treated zinc oxide (zinc oxide surface-treated with a silane coupling agent) is stirred and mixed with 500 parts by mass of tetrahydrofuran, a solution obtained by dissolving 0.6 parts by mass of alizarin in 50 parts by mass of tetrahydrofuran is added thereto, and the mixture is stirred at 50° C. for 5 hours. Thereafter, zinc oxide to which alizarin is added is filtered off by vacuum filtration, and further dried under reduced pressure at 60° C. to obtain zinc oxide to which alizarin is added.

A mixed solution is obtained by mixing 60 parts by mass of the zinc oxide to which alizarin is added, 13.5 parts by mass of a curing agent (blocked isocyanate, SUMIDUR 3175, manufactured by Sumitomo Bayer Urethane Co., Ltd.), 15 parts by mass of a butyral resin (S-LEC BM-1, manufactured by Sekisui Chemical Co., Ltd.), and 85 parts by mass of methyl ethyl ketone. 38 parts by mass of the mixed solution and 25 parts by mass of methyl ethyl ketone are mixed and dispersed for 2 hours in a sand mill using glass beads having a diameter of 1 mmφ, thereby obtaining a dispersion.

0.005 parts by mass of dioctyl tin dilaurate as a catalyst and 40 parts by mass of silicone resin particles (trade name: TOSPEARL 145, manufactured by Momentive Performance Materials Inc.) are added to the obtained dispersion to obtain a coating solution for forming an undercoat layer. An aluminum substrate having a diameter of 60 mm, a length of 357 mm, and a thickness of 1 mm is coated with the coating solution by a dip coating method, and dried and cured at 170° C. for 40 minutes, thereby forming an undercoat layer having a thickness of 19 μm.

### Production of Charge Generation Layer

A mixture of 15 parts by mass of hydroxygallium phthalocyanine having diffraction peaks at positions where Bragg angles (2θ±0.2°) in an X-ray diffraction spectrum using Cuka characteristic X-rays are at least 7.3°, 16.0°, 24.9°, and 28.0° as a charge generation material, 10 parts by mass of vinyl chloride-vinyl acetate copolymer resin (VMCH; manufactured by Nippon Unicar Company Limited) as a binder resin, and 200 parts by mass of n-butyl acetate is dispersed in a sand mill for 4 hours using glass beads having a diameter of 1 mmφ. 175 parts by mass of n-butyl acetate and 180 parts by mass of methyl ethyl ketone are added to the obtained dispersion liquid, and the mixture is stirred, thereby obtaining a coating solution for forming a charge generation layer. The undercoat layer is dipped in and coated with the coating solution for forming a charge generation layer, and dried at normal temperature (25° C.) to form a charge generation layer having a film thickness of 0.2 μm.

### Production of Charge Transport Layer

First, 300 parts by mass of a trimethylsilane compound (1,1,1,3,3,3-hexamethyldisilazane (manufactured by Tokyo Chemical Industry Co., Ltd.)) serving as a hydrophobic agent is added to 100 parts by mass of untreated (hydrophilic) silica particles “trade name: OX50 (manufactured by Nippon Aerosil Co., Ltd.), specific surface area: 50 m²/g”, the mixture is allowed to react for 24 hours and filtered, thereby obtaining hydrophobized silica particles. The particles are used as silica particles (1).

Next, 250 parts by mass of tetrahydrofuran is added to 50 parts by mass of the silica particles (1) as metal oxide particles, 25 parts by mass of 4-(2,2-diphenylethyl)-4′,4″-dimethyl-triphenylamine as a charge transport material and 25 parts by mass of the bisphenol Z type polycarbonate resin (viscosity-average molecular weight: 30,000) as a binder resin are added thereto while the liquid temperature is maintained at 20° C., and the mixture is stirred and mixed for 12 hours, thereby obtaining a coating solution for forming a charge transport layer.

The charge generation layer is coated with the coating solution for forming a charge transport layer and dried at 135° C. for 40 minutes to form a charge transport layer having a film thickness of 30 μm, thereby obtaining an organic photoreceptor (1).

The organic photoreceptor (1) in which the undercoat layer, the charge generation layer, and the charge transport layer are laminated and formed in this order on the aluminum substrate is obtained by performing the above-described steps.

### Formation of Inorganic Protective Layer

Next, an inorganic protective layer formed of gallium oxide containing hydrogen is formed on the surface of the organic photoreceptor (1). The inorganic protective layer is formed using a film forming device having the configuration shown in FIGS. 2A and 2B.

First, the organic photoreceptor (1) is placed on the substrate support member 213 in the film forming chamber 210 of the film forming device, and vacuum exhaust is carried out in the film forming chamber 210 through the exhaust port 211 until the pressure reaches 0.1 Pa.

Next, He-diluted 40% oxygen gas (flow rate of 1.6 sccm) and hydrogen gas (flow rate of 50 sccm) are introduced from the gas introduction pipe 220 into the high-frequency discharge tube portion 221 provided with the flat plate electrode 219 having a diameter of 85 mm, and a radio wave at a frequency of 13.56 MHz is set at an output of 150 W by the high-frequency power supply portion 218 and a matching circuit (not shown in FIGS. 2A and 2B), matched with a tuner, and discharged from the flat plate electrode 219. A reflected wave at this time is 0 W.

Next, trimethyl gallium gas (flow rate of 1.9 sccm) is introduced from the shower nozzle 216 to the plasma diffusion portion 217 in the film forming chamber 210 through the gas introduction pipe 215. Here, a reaction pressure in the film forming chamber 210 measured by a Baratron vacuum gauge is 5.3 Pa.

Film formation is carried out for 68 minutes while the organic photoreceptor (1) rotates at a speed of 500 rpm in the state, and an inorganic protective layer having a film thickness of 1.5 μm is formed on the surface of the charge transport layer of the organic photoreceptor (1).

A surface roughness Ra on the outer peripheral surface of the inorganic protective layer is 1.9 nm.

An element compositional ratio (oxygen/gallium) of oxygen to gallium in the inorganic protective layer is 1.5.

An electrophotographic photoreceptor in which the undercoat layer, the charge generation layer, the charge transport layer, and the inorganic protective layer are formed in this order on the conductive substrate is obtained by performing the above-described steps.

### Examples 2 to 31 and Comparative Examples 1 to 4

A photoreceptor is obtained in the same manner as in Example 1, except that the following items are changed according to Table 1. However, in Example 12, trimethylaluminum gas (TMA) is used instead of trimethylgallium gas (TMG). In Table 1, “O/Ga ratio” of Example 12 indicates “O/Al ratio”.
Film thickness of the charge transport layer
Type and content of the metal oxide particles in the charge transport layer
Film thickness of the inorganic protective layer
Flow rate ratio of oxygen gas and trimethylgallium gas during the formation of the inorganic protective layer

### Various Measurements

The following items are measured by the methods described above.
Relative permittivity of the charge transport layer and the inorganic protective layer
Capacitance of the charge transport layer and the inorganic protective layer: indicated as “X1, X2” in Table 1
Ratio of capacitance of the charge transport layer to the capacitance of the inorganic protective layer: indicated as “X1/X2” in Table 1
Amount of OH group of the metal oxide particles in the charge transport layer
Compositional ratio of oxygen/Group 13 element (indicated as O/Ga ratio) in the inorganic protective layer

### Performance Evaluation of Photoreceptor

### Charging Property

Charging property of the photoreceptor of each example is evaluated as follows.

The photoreceptor of each of Examples and Comparative Examples is attached to an image forming apparatus (DocuCentre-V C7775, manufactured by FUJIFILM Business Innovation Corp.). Potential decay of the photoreceptor after charging is monitored at two sites at equal intervals in the axial direction of the photoreceptor, and the results are classified as follows. The results are shown in Table 1.
G1: uniformly charged up to the target charging potential
G2: substantially charged to the target charging potential
G3: variation in charging potential
G4: not charged to the target charging potential

### Evaluation of Dot Reproducibility

Dot reproducibility of each example is evaluated as follows.

The photoreceptor of each of Examples and Comparative Examples is attached to an image forming apparatus (DocuCentre-V C7775, manufactured by FUJIFILM Business Innovation Corp.), and the dot reproducibility is evaluated by the following procedure.

Specifically, the shape of the dots is observed using a 50% halftone image, and the presence or absence of dot variation and size fluctuation due to lateral flow of dots is evaluated.
G1: no variation in dots
G2: some variation in dots
G3: variation in dots
G4: large variation in size of dots

### Comprehensive Evaluation

Regarding the photoreceptor of each example, the overall evaluation is carried out as follows based on the evaluation results.

The photoreceptors of each of Examples and Comparative Examples are classified as follows based on the evaluation results of the charging property and the dot reproducibility.
A: both the charging property and the dot reproducibility are excellent.
B: although either the charging property or the dot reproducibility is lowered, it is acceptable in actual use.
C: both the charging property and the dot reproducibility are deteriorated, but it is acceptable in actual use.
D: both the charging property and the dot reproducibility are deteriorated, that is not acceptable in actual use.

In Table 1, the notation of “(Numerical value A)E-(numerical value B)” means numerical value A×10^{-(numerical value B)}.

TABLE 1

| | Charge transport layer | | | | | | Inorganic protective layer | |
|---|---|---|---|---|---|---|---|---|
| | | Metal oxide particles | | | | | Flow rate | |
| | | | | Degree of | Film | Capacitance | ratio of | |
| | Relative | | Content | hydrophobicity | thickness | (X1) | TMG/O₂ | O/Ga |
| | permittivity | Type | (vol %) | (%) | (m) | (F/m²) | gas | ratio |
| Example 1 | 3.3 | Silica (1) | 60 | 65 | 2.5.E−05 | 1.17.E−06 | 3.0 | 1.5 |
| Example 2 | 3.4 | Silica (2) | 60 | 60 | 1.6.E−05 | 1.88.E−06 | 3.0 | 1.5 |
| Example 3 | 3.4 | Silica (2) | 60 | 60 | 1.6.E−05 | 1.88.E−06 | 2.0 | 1.4 |
| Example 4 | 3.2 | Silica (1) | 40 | 65 | 3.0.E−05 | 9.44.E−07 | 2.0 | 1.4 |
| Example 5 | 3.2 | Silica (1) | 40 | 65 | 3.0.E−05 | 9.44.E−07 | 3.0 | 1.5 |
| Example 6 | 3.2 | Silica (1) | 40 | 65 | 3.0.E−05 | 9.44.E−07 | 3.0 | 1.5 |
| Example 7 | 3.3 | Silica (1) | 60 | 65 | 2.0.E−05 | 1.46.E−06 | 2.0 | 1.4 |
| Example 8 | 3.2 | Silica (1) | 40 | 65 | 3.0.E−05 | 9.44.E−07 | 2.0 | 1.4 |
| Example 9 | 3.2 | Silica (1) | 40 | 65 | 2.5.E−05 | 1.13.E−06 | 2.0 | 1.4 |
| Example 10 | 3.4 | Silica (2) | 60 | 60 | 1.6.E−05 | 1.88.E−06 | 3.0 | 1.5 |
| Example 11 | 3.4 | Silica (2) | 60 | 60 | 1.6.E−05 | 1.88.E−06 | 3.0 | 1.5 |
| Example 12 | 3.3 | Silica (1) | 60 | 65 | 2.5.E−05 | 1.17.E−06 | TMA/O₂ | 1.5 |
| | | | | | | | 3.0 | |
| Example 13 | 3.3 | Silica (1) | 60 | 65 | 2.5.E−05 | 1.17.E−06 | 1.8 | 1.38 |
| Example 14 | 3.3 | Silica (1) | 60 | 65 | 2.5.E−05 | 1.17.E−06 | 2.0 | 1.4 |
| Example 15 | 3.3 | Silica (1) | 60 | 65 | 2.5.E−05 | 1.17.E−06 | 3.0 | 1.5 |
| Example 16 | 3.3 | Silica (1) | 60 | 65 | 2.5.E−05 | 1.17.E−06 | 3.5 | 1.52 |
| Example 17 | 3.6 | Titanium | 60 | — | 2.5.E−05 | 1.27.E−06 | 3.0 | 1.5 |
| | | oxide | | | | | | |
| Example 18 | 3.1 | Silica (1) | 10 | 65 | 3.0.E−05 | 9.15.E−07 | 3.0 | 1.5 |
| Example 19 | 3.2 | Silica (1) | 40 | 65 | 3.0.E−05 | 9.44.E−07 | 3.0 | 1.5 |
| Example 20 | 3.3 | Silica (1) | 60 | 65 | 3.0.E−05 | 9.74.E−07 | 3.0 | 1.5 |
| Example 21 | 3.6 | Silica (1) | 80 | 65 | 2.5.E−05 | 1.27.E−06 | 3.0 | 1.5 |
| Example 22 | 3.7 | Silica (3) | 60 | 55 | 2.2.E−05 | 1.49.E−06 | 3.0 | 1.5 |
| Example 23 | 3.3 | Silica (1) | 60 | 60 | 2.2.E−05 | 1.33.E−06 | 3.0 | 1.5 |
| Example 24 | 3.3 | Silica (1) | 60 | 60 | 1.5.E−05 | 1.90.E−06 | 3.0 | 1.5 |
| Example 25 | 3.3 | Silica (1) | 60 | 60 | 1.6.E−05 | 1.83.E−06 | 3.0 | 1.5 |
| Example 26 | 3.3 | Silica (1) | 60 | 60 | 3.0.E−05 | 9.74.E−07 | 3.0 | 1.5 |
| Example 27 | 3.3 | Silica (1) | 60 | 60 | 3.1.E−05 | 9.43.E−07 | 3.0 | 1.5 |
| Example 28 | 3.3 | Silica (1) | 60 | 65 | 2.5.E−05 | 1.17.E−06 | 3.0 | 1.5 |
| Example 29 | 3.3 | Silica (1) | 60 | 65 | 2.5.E−05 | 1.17.E−06 | 3.0 | 1.5 |
| Example 30 | 3.3 | Silica (1) | 60 | 65 | 2.5.E−05 | 1.17.E−06 | 3.0 | 1.5 |
| Example 31 | 3.3 | Silica (1) | 60 | 65 | 2.5.E−05 | 1.17.E−06 | 3.5 | 1.52 |
| Comparative | 3.3 | Silica (1) | 60 | 65 | 1.5.E−05 | 1.95.E−06 | 3 | 20 |
| Example 1 | | | | | | | | |
| Comparative | 3.18 | None | 0 | — | 4.5.E−05 | 6.26.E−07 | 3 | 20 |
| Example 2 | | | | | | | | |
| Comparative | 3.3 | Silica (1) | 60 | 65 | 2.5.E−05 | 1.17.E−06 | 0.8 | 5 |
| Example 3 | | | | | | | | |
| Comparative | 3.3 | | 60 | 65 | 2.5.E−05 | 1.17.E−06 | 3 | 20 |
| Example 4 | | | | | | | | |

| | Inorganic protective layer | | | | | | |
|---|---|---|---|---|---|---|---|
| | | Film | Capacitance | Ratio of | | | |
| | Relative | thickness | (X2) | capacitance | Charging | Dot | Comprehensive |
| | permittivity | (m) | (F/m²) | (X1/X2) | property | reproducibility | evaluation |
| Example 1 | 11 | 3.0.E−06 | 3.2.E−05 | 0.036 | G1 | G1 | A |
| Example 2 | 11 | 4.0.E−06 | 2.4.E−05 | 0.077 | G3 | G2 | C |
| Example 3 | 11.8 | 1.0.E−06 | 1.0.E−04 | 0.018 | G3 | G2 | C |
| Example 4 | 11.8 | 1.0.E−06 | 1.0.E−04 | 0.009 | G2 | G2 | C |
| Example 5 | 11 | 4.0.E−06 | 2.4.E−05 | 0.039 | G2 | G2 | C |
| Example 6 | 11 | 4.0.E−06 | 2.4.E−05 | 0.039 | G2 | G1 | B |
| Example 7 | 11.8 | 2.0.E−06 | 5.2.E−05 | 0.028 | G2 | G1 | B |
| Example 8 | 11.8 | 1.0.E−06 | 1.0.E−04 | 0.009 | G2 | G2 | C |
| Example 9 | 11.8 | 1.0.E−06 | 1.0.E−04 | 0.011 | G1 | G1 | A |
| Example 10 | 11 | 3.5.E−06 | 2.8.E−05 | 0.068 | G1 | G1 | A |
| Example 11 | 11 | 4.0.E−06 | 2.4.E−05 | 0.077 | G2 | G2 | C |
| Example 12 | 11.7 | 3.0.E−06 | 3.5.E−05 | 0.034 | G2 | G2 | C |
| Example 13 | 12 | 3.0.E−06 | 3.5.E−05 | 0.033 | G2 | G2 | C |
| Example 14 | 11.8 | 3.0.E−06 | 3.5.E−05 | 0.034 | G1 | G1 | A |
| Example 15 | 11 | 3.0.E−06 | 3.2.E−05 | 0.036 | G1 | G1 | A |
| Example 16 | 11.8 | 3.0.E−06 | 3.5.E−05 | 0.034 | G2 | G2 | C |
| Example 17 | 11 | 3.0.E−06 | 3.2.E−05 | 0.039 | G2 | G2 | C |
| Example 18 | 11 | 3.0.E−06 | 3.2.E−05 | 0.028 | G2 | G2 | C |
| Example 19 | 11 | 3.0.E−06 | 3.2.E−05 | 0.029 | G1 | G1 | A |
| Example 20 | 11 | 3.0.E−06 | 3.2.E−05 | 0.030 | G1 | G1 | A |
| Example 21 | 11 | 3.0.E−06 | 3.2.E−05 | 0.039 | G2 | G2 | C |
| Example 22 | 11 | 3.0.E−06 | 3.2.E−05 | 0.046 | G2 | G2 | C |
| Example 23 | 11 | 3.0.E−06 | 3.2.E−05 | 0.041 | G1 | G1 | A |
| Example 24 | 11 | 3.0.E−06 | 3.2.E−05 | 0.058 | G2 | G2 | C |
| Example 25 | 11 | 3.0.E−06 | 3.2.E−05 | 0.056 | G1 | G1 | A |
| Example 26 | 11 | 3.0.E−06 | 3.2.E−05 | 0.030 | G1 | G1 | A |
| Example 27 | 11 | 3.0.E−06 | 3.2.E−05 | 0.029 | G2 | G2 | C |
| Example 28 | 11 | 9.0.E−07 | 1.1.E−04 | 0.011 | G2 | G2 | C |
| Example 29 | 11 | 1.0.E−06 | 9.7.E−05 | 0.012 | G1 | G1 | A |
| Example 30 | 11 | 4.0.E−06 | 2.4.E−05 | 0.048 | G1 | G1 | A |
| Example 31 | 11.8 | 4.2.E−06 | 2.5.E−05 | 0.047 | G2 | G2 | C |
| Comparative | 11 | 3.0.E−06 | 3.2.E−05 | 0.060 | G4 | G3 | D |
| Example 1 | | | | | | | |
| Comparative | 11 | 3.0.E−06 | 3.2.E−05 | 0.019 | G4 | G3 | D |
| Example 2 | | | | | | | |
| Comparative | 15 | 1.0.E−06 | 1.3.E−04 | 0.009 | G1 | G4 | D |
| Example 3 | | | | | | | |
| Comparative | 11 | 5.0.E−06 | 1.9.E−05 | 0.060 | G1 | G4 | D |
| Example 4 | | | | | | | |

The abbreviations shown in Table 1 mean the following compounds.

### Metal Oxide Particles

Silica particles (1) degree of hydrophobicity: 65%, trade name: OX50 (manufactured by Nippon Aerosil Co., Ltd.), reaction time: 24 hours

Silica particles (2) degree of hydrophobicity: 60%, trade name: OX50 (manufactured by Nippon Aerosil Co., Ltd.), reaction time: 20 hours

Silica particles (3) degree of hydrophobicity: 55%, trade name: OX50 (manufactured by Nippon Aerosil Co., Ltd.), reaction time: 15 hours

Other than silica: titanium oxide

From the above results, it is found that the photoreceptors of Examples are excellent in both the charging property and the dot reproducibility as compared with the photoreceptors of Comparative Examples.

The present exemplary embodiments include the following aspects.

(((1)))

An electrophotographic photoreceptor comprising:
a conductive substrate;
a charge generation layer that is disposed on the conductive substrate;
a charge transport layer that is disposed on the charge generation layer; and
an inorganic protective layer that is disposed on the charge transport layer,
wherein a capacitance (X1) of the charge transport layer per unit area is 0.90×10⁻⁶ (F/m²) or more and 1.90×10⁻⁶ (F/m²) or less, and
a capacitance (X2) of the inorganic protective layer per unit area is 2.40×10⁻⁵ (F/m²) or more and 1.10×10⁻⁴ (F/m²) or less.
   (((2)))

The electrophotographic photoreceptor according to (((1))),
wherein the capacitance (X1) of the charge transport layer per unit area is 0.90×10⁻⁶ (F/m²) or more and 1.46×10⁻⁶ (F/m²) or less, and
the capacitance (X2) of the inorganic protective layer per unit area is 2.40×10⁻⁵ (F/m²) or more and 5.30×10⁻⁵ (F/m²) or less.
   (((3)))

The electrophotographic photoreceptor according to (((1))) or (((2))),
wherein a ratio (X1/X2) of the capacitance (X1) of the charge transport layer per unit area to the capacitance (X2) of the inorganic protective layer per unit area is 0.010 or more and 0.070 or less.
   (((4)))

The electrophotographic photoreceptor according to any one of (((1))) to (((3))),
wherein the inorganic protective layer is an inorganic protective layer containing oxygen and a Group 13 element.
   (((5)))

The electrophotographic photoreceptor according to (((4))),
wherein an element compositional ratio (oxygen/Group 13 element) of the oxygen to the Group 13 element in the inorganic protective layer is 1.4 or more and 1.5 or less.
   (((6)))

The electrophotographic photoreceptor according to any one of (((1))) to (((5))),
wherein the charge transport layer contains metal oxide particles.
   (((7)))

The electrophotographic photoreceptor according to (((6))),
wherein the metal oxide particles are silica particles.
   (((8)))

The electrophotographic photoreceptor according to (((7))),
wherein a content of the metal oxide particles with respect to the charge transport layer is 40% by volume or more and 60% by volume or less.
   (((9)))

The electrophotographic photoreceptor according to (((6))),
wherein a degree of hydrophobicity of the metal oxide particles in the charge transport layer is 60% or more.
   (((10)))

The electrophotographic photoreceptor according to any one of (((1))) to (((9))),
wherein a film thickness of the charge transport layer is 16 μm or more and 30 μm or less.
   (((11)))

The electrophotographic photoreceptor according to any one of (((1))) to (((10))),
wherein a film thickness of the inorganic protective layer is 1.0 μm or more and 4.0 μm or less.
   (((12)))

A process cartridge comprising:
the electrophotographic photoreceptor according to any one of (((1))) to (((11))),
wherein the process cartridge is attachable to and detachable from an image forming apparatus.
   (((13)))

An image forming apparatus comprising:
the electrophotographic photoreceptor according to any one of (((1))) to (((11)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
a charge generation layer that is disposed on the conductive substrate;
a charge transport layer that is disposed on the charge generation layer; and
an inorganic protective layer that is disposed on the charge transport layer,
wherein a capacitance (X1) of the charge transport layer per unit area is 0.90×10⁻⁶ (F/m²) or more and 1.90×10⁻⁶ (F/m²) or less, and
a capacitance (X2) of the inorganic protective layer per unit area is 2.40×10⁻⁵ (F/m²) or more and 1.10×10⁻⁴ (F/m²) or less.

2. The electrophotographic photoreceptor according to claim 1,
wherein the capacitance (X1) of the charge transport layer per unit area is 0.90×10⁻⁶ (F/m²) or more and 1.46×10⁻⁶ (F/m²) or less, and
the capacitance (X2) of the inorganic protective layer per unit area is 2.40×10⁻⁵ (F/m²) or more and 5.30×10⁻⁵ (F/m²) or less.

3. The electrophotographic photoreceptor according to claim 1,
wherein a ratio (X1/X2) of the capacitance (X1) of the charge transport layer per unit area to the capacitance (X2) of the inorganic protective layer per unit area is 0.010 or more and 0.070 or less.

4. The electrophotographic photoreceptor according to claim 1,
wherein the inorganic protective layer is an inorganic protective layer containing oxygen and a Group 13 element.

5. The electrophotographic photoreceptor according to claim 4,
wherein an element compositional ratio (oxygen/Group 13 element) of the oxygen to the Group 13 element in the inorganic protective layer is 1.4 or more and 1.5 or less.

6. The electrophotographic photoreceptor according to claim 1,
wherein the charge transport layer contains metal oxide particles.

7. The electrophotographic photoreceptor according to claim 6,
wherein the metal oxide particles are silica particles.

8. The electrophotographic photoreceptor according to claim 7,
wherein a content of the metal oxide particles with respect to the charge transport layer is 40% by volume or more and 60% by volume or less.

9. The electrophotographic photoreceptor according to claim 6,
wherein a degree of hydrophobicity of the metal oxide particles in the charge transport layer is 60% or more.

10. The electrophotographic photoreceptor according to claim 1,
wherein a film thickness of the charge transport layer is 16 μm or more and 30 μm or less.

11. The electrophotographic photoreceptor according to claim 1,
wherein a film thickness of the inorganic protective layer is 1.0 μm or more and 4.0 μm or less.

12. A process cartridge comprising:
the electrophotographic photoreceptor according to claim 1,
wherein the process cartridge is attachable to and detachable from an image forming apparatus.

13. A process cartridge comprising:
the electrophotographic photoreceptor according to claim 2,
wherein the process cartridge is attachable to and detachable from an image forming apparatus.

14. A process cartridge comprising:
the electrophotographic photoreceptor according to claim 3,
wherein the process cartridge is attachable to and detachable from an image forming apparatus.

15. A process cartridge comprising:
the electrophotographic photoreceptor according to claim 4,
wherein the process cartridge is attachable to and detachable from an image forming apparatus.

16. A process cartridge comprising:
the electrophotographic photoreceptor according to claim 5,
wherein the process cartridge is attachable to and detachable from an image forming apparatus.

17. A process cartridge comprising:
the electrophotographic photoreceptor according to claim 6,
wherein the process cartridge is attachable to and detachable from an image forming apparatus.

18. A process cartridge comprising:
the electrophotographic photoreceptor according to claim 7,
wherein the process cartridge is attachable to and detachable from an image forming apparatus.

19. A process cartridge comprising:
the electrophotographic photoreceptor according to claim 8,
wherein the process cartridge is attachable to and detachable from an image forming apparatus.

20. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
